(19) United States
(12) Patent Application Publication
(10) Pub. No.: US 2025/0198476 A1
(43) Pub. Date: Jun. 19, 2025

(54) SPRING MEMBER

(71) Applicant: NHK SPRING Co., Ltd., Yokohama-shi, Kanagawa (JP)

(72) Inventors: Norihiro TAJIMA, Yokohama-shi (JP); Atsushi YONEOKA, Yokohama-shi (JP); Shuji TAKAHASHI, Yokohama-shi (JP)

(21) Appl. No.: 18/857,500

(22) PCT Filed: Apr. 24, 2023
(86) PCT No.: PCT/JP2023/016145

§ 371 Date: Oct. 17, 2024

(30) Foreign Application Priority Data
Apr. 26, 2022 (JP) 2022-072069

(51) Int. Cl. F16F 1/18

(52) U.S. Cl. CPC F16F 1/185; F16F 2238/022

(57) ABSTRACT

A spring member presses a first pressed body and a second pressed body in directions away from each other in a first direction, and includes a plurality of spring units each including a first member and a second member, in which the first member is formed of a material having at least one of electrical conductivity and thermal conductivity higher than a material forming the second member, the first member includes first abutting portions and a second abutting portion, both end portions of the second member press the first pressed body via the first abutting portions, and an intermediate portion of the second member presses the second pressed body via the second abutting portion, and one end portion of one spring unit is provided at a position shifted in the second direction from one end portion of another spring unit adjacent to the one spring unit.

### TECHNICAL FIELD

The present invention relates to a spring member.

Priority is claimed on Japanese Patent Application No. 2022-072069, filed Apr. 26, 2022, the content of which is incorporated herein by reference.

### BACKGROUND ART

In the related art, as shown in Patent Document 1, for example, a spring member is known which is provided between a first pressed body and a second pressed body, which face each other in a first direction, in a state of pressing the first pressed body and the second pressed body in directions away from each other in the first direction.

### CITATION LIST

### Patent Document

Patent Document 1: Japanese Unexamined Patent Application, First Publication No. 2014-11936

### SUMMARY OF INVENTION

### Problem to be Solved by the Invention

In the spring member in the related art, in a case of attempting to use the spring member to conduct a current or transfer heat from one of the first pressed body and the second pressed body to the other, it is difficult to stably exhibit characteristics of the spring member, such as conductivity and heat transfer properties, as designed while prioritizing load characteristics of the spring member.

The present invention has been made in consideration of such circumstances, and an object of the present invention is to provide a spring member capable of stably exhibiting characteristics such as conductivity and heat transfer properties as designed.

### Means to Solve the Problem

According to an aspect of the present invention, there is provided a spring member that presses a first pressed body and a second pressed body, which face each other in a first direction, in directions away from each other in the first direction, the spring member including a plurality of spring units each including a first member and a second member, in which the first member is formed of a material having at least one of electrical conductivity and thermal conductivity higher than a material forming the second member, the first member includes first abutting portions which are formed at both end portions thereof in a second direction orthogonal to the first direction and abut on the first pressed body, and a second abutting portion which is formed at an intermediate portion thereof in the second direction and abuts on the second pressed body, both end portions of the second member in the second direction press the first pressed body via the first abutting portions, and an intermediate portion of the second member in the second direction presses the second pressed body via the second abutting portion, the plurality of spring units are provided to be arranged in a third direction orthogonal to the first direction and the second direction, and one end portion, in the second direction, of at least one spring unit of the plurality of spring units is provided at a position shifted in the second direction from one end portion, in the second direction, of another spring unit adjacent to the at least one spring unit in the third direction.

According to the above aspect, the spring member includes the first member and the second member. By providing the spring member between the first pressed body and the second pressed body and elastically deforming the second member in the first direction together with the first member, it is possible to strongly bring the first abutting portions of the first member into contact with the first pressed body and to strongly bring the second abutting portion of the first member into contact with the second pressed body, so that characteristics mainly of the first member, such as conductivity and heat transfer properties, can be stably exhibited as designed.

The intermediate portion of the second member in the second direction presses the second pressed body via the second abutting portion of the first member. Therefore, it is possible to reliably and strongly bring the second abutting portion into contact with the second pressed body, so that a contact state of the first member with respect to the first pressed body and the second pressed body can be reliably stabilized.

Since the spring member is provided with the first member and a surface of the second member is not plated with the same material as the first member, at least one of the electrical conductivity and thermal conductivity can be easily secured at a high level, peeling of the plating does not occur, and the above-mentioned characteristics as designed can be exhibited for a long period of time.

One end portion, in the second direction, of at least one spring unit of the plurality of spring units provided to be arranged in the third direction is provided at a position shifted in the second direction from one end portion, in the second direction, of another spring unit adjacent to this spring unit in the third direction.

Therefore, compared to a case where both end portions in the second direction are located at the same position in the second direction for all of the plurality of spring units, for example, there may be cases where the first abutting portion of the first member is easily brought into accurate contact with a specific portion of the first pressed body, and it is possible to suppress limitations on portions to which the spring member is applied.

The first member and the second member may each be curved or bent such that the intermediate portions thereof in the second direction protrude toward the second pressed body.

A protruding portion that protrudes in the third direction may be provided to at least one spring unit of the plurality of spring units, the protruding portion may include a conductive portion that is integrally formed of the same material as the first member, and a support portion that is integrally formed of the same material as the second member, a fourth abutting portion that abuts on the first pressed body or the second pressed body may be formed at a tip end portion of the conductive portion in the third direction, and the tip end portion of the conductive portion in the third direction may be locked to a tip end portion of the support portion in the third direction.

Since the protruding portion is provided to the spring unit, the fourth abutting portion of the conductive portion formed of the same material as the first member can be brought into contact with the first pressed body or the second pressed body, as well as the first abutting portion or the second abutting portion. In addition, by providing the protruding portion between the first pressed body and the second pressed body in a state of being elastically deformed in the first direction, the fourth abutting portion of the conductive portion can be strongly brought into contact with the first pressed body or the second pressed body. As a result, characteristics such as conductivity and heat transfer properties can be stably exhibited as designed.

Since the protruding portion protrudes from the spring unit in the third direction, it is possible to bring the first member and the conductive portion into contact with the first pressed body or the second pressed body over a wide range, so that characteristics such as conductivity and heat transfer properties can be reliably improved.

### Effects of the Invention

According to the invention, the characteristics of the spring member, such as conductivity and heat transfer properties, can be stably exhibited as designed.

### BRIEF DESCRIPTION OF DRAWINGS

FIG. 1A is a plan view of a spring member shown as a first embodiment as viewed from the other side in a first direction.

FIG. 1B is a cross-sectional view taken along the line 1B-1B of FIG. 1A.

FIG. 2A is a plan view of a spring member shown as a second embodiment as viewed from the other side in the first direction.

FIG. 2B is a cross-sectional view taken along the line 2B-2B of FIG. 2A.

FIG. 3 is a cross-sectional view of a spring member shown as a third embodiment.

FIG. 4A is a plan view of a spring member shown as a fourth embodiment as viewed from the other side in the first direction.

FIG. 4B is a cross-sectional view taken along the line 4B-4B of FIG. 4A.

FIG. 4C is a cross-sectional view taken along the line 4C-4C of FIG. 4A.

FIG. 5A is a plan view of a spring member shown as a fifth embodiment as viewed from the other side in the first direction.

FIG. 5B is a cross-sectional view taken along the line 5B-5B of FIG. 5A.

FIG. 6A is a plan view of a spring member shown as a sixth embodiment as viewed from the other side in the first direction.

FIG. 6B is a cross-sectional view taken along the line 6B-6B of FIG. 6A.

FIG. 7A is a plan view of a spring member shown as a seventh embodiment as viewed from the other side in the first direction.

FIG. 7B is a cross-sectional view taken along the line 7B-7B of FIG. 7A.

### DESCRIPTION OF EMBODIMENTS

Hereinafter, embodiments of a spring member according to the present invention will be described with reference to the accompanying drawings.

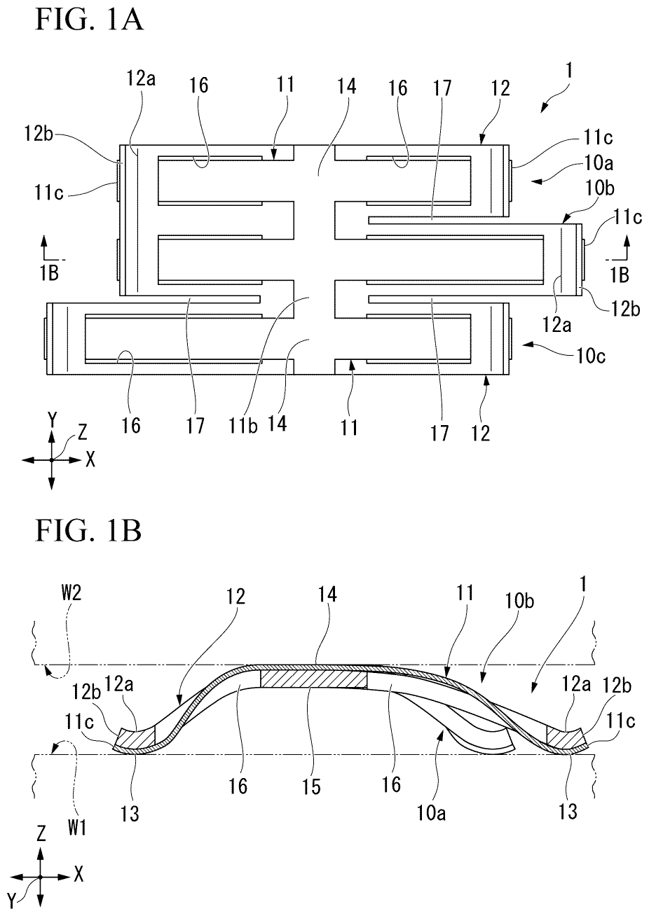

As shown in FIGS. 1A and 1B, a spring member 1 of the present embodiment is provided between a first pressed body W1 and a second pressed body W2, which face each other in a first direction Z, in a state of pressing the first pressed body W1 and the second pressed body W2 in directions away from each other in the first direction Z. The spring member 1 is provided between the first pressed body W1 and the second pressed body W2 in a state of being elastically deformed in the first direction Z.

The spring member 1 includes a plurality of spring units 10a, 10b, and 10c, each including a conductive plate 11 (first member) and a support plate 12 (second member). The conductive plate 11 and the support plate 12 are provided in a state of not being bonded to each other over the entire region.

The conductive plate 11 and the support plate 12 are each curved or bent such that intermediate portions thereof in a second direction X orthogonal to the first direction Z protrude toward the second pressed body W2.

Hereinafter, a side of the first pressed body W1 along the first direction Z is referred to as one side, and a side of the second pressed body W2 along the first direction Z is referred to as the other side.

Along the second direction X, a side away from a center portion toward an end portion is referred to as an outer side, and a side away from the end portion toward the center portion is referred to as an inner side.

A direction orthogonal to the first direction Z and the second direction X is referred to as a third direction Y.

In the shown example, the conductive plate 11 and the support plate 12 each extend toward one side in a direction from the center portion to the outer side along the second direction X. The conductive plate 11 and the support plate 12 may each be bent, for example, to be pointed toward the other side.

The conductive plate 11 is formed of a material having at least one of electrical conductivity and thermal conductivity higher than that of a material forming the support plate 12. The conductive plate 11 is formed of, for example, copper or aluminum. A plate thickness of the conductive plate 11 is, for example, about 50 μm to 100 μm. The support plate 12 is formed of a material having a higher Young's modulus than the material forming the conductive plate 11. The support plate 12 is formed of, for example, carbon steel or stainless steel.

The conductive plate 11 includes first abutting portions 13 that are formed at both end portions thereof in the second direction X and abut on the first pressed body W1, and a second abutting portion 14 that is formed at the intermediate portion thereof in the second direction X and abuts on the second pressed body W2.

The first abutting portion 13 extends in the second direction X such that an open end edge 11c of the conductive plate 11 in the second direction X faces outward in the second direction X. The first abutting portion 13 is curved to have a protruding curved surface toward one side. The first abutting portion 13 is curved around an axis extending in the third direction Y.

The second abutting portion 14 is formed in a flat plate shape with front and back surfaces facing the first direction Z.

The conductive plate 11 has a symmetrical shape with respect to a straight line that passes through a center portion of the conductive plate 11 in the second direction X and extends in the third direction Y as viewed in the first direction Z. The conductive plate 11 has a symmetrical shape with respect to a straight line that passes through a center portion of the conductive plate 11 in the third direction Y and extends in the second direction X as viewed in the first direction Z. The conductive plate 11 has a rectangular shape having a long side in the second direction X as viewed in the first direction Z.

Both end portions of the conductive plate 11 in the second direction X are respectively locked to both end portions of the support plate 12 in the second direction X, and the support plate 12 includes a third abutting portion 15 that is formed at the intermediate portion thereof in the second direction X, abuts on the second abutting portion 14 and sandwiches the second abutting portion 14 between the third abutting portion 15 and the second pressed body W2 in the first direction Z.

The third abutting portion 15 is located at the intermediate portion of the support plate 12 in the second direction X, and is formed in a flat plate shape with front and back surfaces facing the first direction Z. A surface of the third abutting portion 15 facing the other side is covered with the second abutting portion 14 of the conductive plate 11. The third abutting portion 15 and the second abutting portion 14 abut on each other in a state in which the third abutting portion 15 and the second abutting portion 14 are not bonded to each other.

The third abutting portion 15 and the second abutting portion 14 may be bonded to each other. In a state before the spring member 1 is provided between the first pressed body W1 and the second pressed body W2, the third abutting portion 15 and the second abutting portion 14 may be separated from each other in the first direction Z.

Both end portions of the conductive plate 11 in the second direction X are movably locked to both end portions of the support plate 12 in the second direction X, respectively. In the shown example, through-holes 16 are formed at least at both end portions of one of the conductive plate 11 and the support plate 12 in the second direction X, and both end portions of the other in the second direction X are movably inserted into the through-holes 16.

In the shown example, the through-holes 16 are formed in the support plate 12. The first abutting portion 13 of the conductive plate 11 is inserted through the through-hole 16 from the other side to one side in a direction from the inner side to the outer side in the second direction X.

One through-hole 16 is formed in the support plate 12 over the entire region of a portion located between an outer end edge portion 12a, which is connected to an open end edge 12b in the second direction X, and the third abutting portion 15. The through-holes 16 may be, for example, slits that are formed only at both end portions of the support plate 12 in the second direction X and extend in the third direction Y.

In the support plate 12, the outer end edge portion 12a, which is located outside the through-hole 16 in the second direction X and is connected to the open end edge 12b in the second direction X, extends in the second direction X such that the open end edge 12b of the support plate 12 in the second direction X faces outward in the second direction X. The outer end edge portion 12a of the support plate 12 is curved to have a protruding curved surface toward one side. A surface of the outer end edge portion 12a of the support plate 12 facing one side is covered with the first abutting portion 13 of the conductive plate 11. The outer end edge portion 12a of the support plate 12 and the first abutting portion 13 are abut on each other in a state in which the outer end edge portion 12a and the first abutting portion 13 are not bonded to each other. The outer end edge portion 12a of the support plate 12 and the first abutting portion 13 may be bonded to each other.

The support plate 12 has a symmetrical shape with respect to a straight line that passes through a center portion of the support plate 12 in the second direction X and extends in the third direction Y as viewed in the first direction Z. The support plate 12 has a symmetrical shape with respect to a straight line that passes through a center portion of the support plate 12 in the third direction Y and extends in the second direction X as viewed in the first direction Z.

The center portions of the support plate 12 and the conductive plate 11 in the second direction X coincide with each other. The center portions of the support plate 12 and the conductive plate 11 in the third direction Y coincide with each other.

In the shown example, the conductive plate 11 is elastically deformed, and the first abutting portions 13 and the second abutting portion 14 are in pressure contact with the support plate 12 in the first direction Z. In a state before the conductive plate 11 and the support plate 12 are assembled to each other, a size of the support plate 12 in the first direction Z is larger than a size of the conductive plate 11 in the first direction Z.

Portions of the conductive plate 11 and the support plate 12 facing each other in the first direction Z, except for the through-hole 16, may abut on each other over the entire region.

A plurality of the conductive plates 11 and a plurality of the support plates 12 are provided to be arranged in the third direction Y. As a result, the plurality of spring units 10a, 10b, and 10c each including one conductive plate 11 and one support plate 12 are provided to be arranged in the third direction Y. The number of the spring units 10a to 10c is not limited to three as in the shown example, and may be changed as appropriate.

The conductive plates 11 adjacent to each other in the third direction Y are connected to each other only at the intermediate portions in the second direction X via a connecting piece 11b.

A spring member may be adopted in which, for a configuration in which the plurality of conductive plates 11 are integrally formed as described above, the plurality of support plates 12 divided from each other are respectively attached to the plurality of conductive plates 11. A plurality of the connecting pieces 11b may be provided at intervals in the second direction X.

The support plates 12 adjacent to each other in the third direction Y are connected to each other.

A spring member may be adopted in which, for a configuration in which the plurality of support plates 12 are integrally formed as described above, the plurality of conductive plates 11 divided from each other are respectively attached to the plurality of support plates 12.

Here, one end portion, in the second direction X, of at least one spring unit 10a to 10c of the plurality of spring units 10a to 10c is provided at a position shifted in the second direction X from one end portion, in the second direction X, of another spring unit 10a to 10c adjacent to this spring unit 10a to 10c in the third direction Y.

A slit 17 that extends in the second direction X is formed in a part that connects the support plates 12 of the two spring units 10a to 10c, which are adjacent to each other in the third direction Y and of which positions in the second direction X of one end portions in the second direction X are shifted from each other, and the slit 17 is provided at a portion of the part located on a side of one end portion in the second direction X.

In the shown example, the spring member 1 is configured by arranging the first spring unit 10a, the second spring unit 10b, and the third spring unit 10c in the third direction Y.

One end portion of the second spring unit 10b in the second direction X is shifted to the side of one end portion in the second direction X, from one end portion of the first spring unit 10a in the second direction X and from one end portion of the third spring unit 10c in the second direction X. In the second spring unit 10b, when viewed in the third direction Y, a radius of curvature of a portion located on the side of one end portion in the second direction X is larger than a radius of curvature of a portion located on a side of the other end portion in the second direction X.

The slit 17 is formed in a part that connects the support plate 12 of the first spring unit 10a and the support plate 12 of the second spring unit 10b, and provided at a portion in the part located on the side of one end portion in the second direction X. In addition, the slit 17 is formed in a part that connects the support plate 12 of the second spring unit 10b and the support plate 12 of the third spring unit 10c, and provided at a portion of the part located on the side of one end portion in the second direction X. The slits 17 are open on the side of one end portion in the second direction X.

The other end portion of the third spring unit 10c in the second direction X is shifted to the side of the other end portion in the second direction X, from the other end portion of the first spring unit 10a in the second direction X and from the other end portion of the second spring unit 10b in the second direction X. In the third spring unit 10c, when viewed in the third direction Y, a radius of curvature of a portion located on the side of the other end portion in the second direction X is larger than a radius of curvature of a portion located on the side of one end portion in the second direction X.

The slit 17 is formed in a part that connects the support plate 12 of the second spring unit 10b and the support plate 12 of the third spring unit 10c, and is provided at a portion of the part located on the side of the other end portion in the second direction X. The slit 17 is open on the side of the other end portion in the second direction X.

As described above, the spring member 1 according to the present embodiment includes the conductive plate 11 and the support plate 12. By providing the spring member 1 between the first pressed body W1 and the second pressed body W2 and elastically deforming the support plate 12 in the first direction Z together with the conductive plate 11, it is possible to strongly bring the first abutting portions 13 of the conductive plate 11 into contact with the first pressed body W1 and to strongly bring the second abutting portion 14 into contact with the second pressed body W2, so that characteristics mainly of the conductive plate 11, such as conductivity and heat transfer properties, can be stably exhibited as designed.

The third abutting portion 15 that abuts on the second abutting portion 14 of the conductive plate 11 and sandwiches the second abutting portion 14 between the third abutting portion 15 and the second pressed body W2 in the first direction Z is formed in the support plate 12. The third abutting portion 15 presses the second pressed body W2 via the second abutting portion 14. Therefore, it is possible to reliably and strongly bring the second abutting portion 14 into contact with the second pressed body W2, so that a contact state of the conductive plate 11 with respect to the first pressed body W1 and the second pressed body W2 can be reliably stabilized.

Since the spring member 1 is provided with the conductive plate 11 and a surface of the support plate 12 is not plated with the same material as the conductive plate 11, at least one of the electrical conductivity and thermal conductivity can be easily secured at a high level, peeling of the plating does not occur, and the above-mentioned characteristics as designed can be exhibited for a long period of time.

One end portion, in the second direction X, of at least one spring unit 10a to 10c of the plurality of spring units 10a to 10c is provided at a position shifted in the second direction X from one end portion, in the second direction X, of another spring unit 10a to 10c adjacent to this spring unit 10a to 10c in the third direction Y.

Therefore, compared to a case where both end portions in the second direction X are located at the same position in the second direction X for all of the plurality of spring units 10a to 10c, for example, there may be cases where the first abutting portion 13 of the conductive plate 11 is easily brought into accurate contact with a specific portion of the first pressed body W1, and it is possible to suppress limitations on portions to which the spring member 1 is applied.

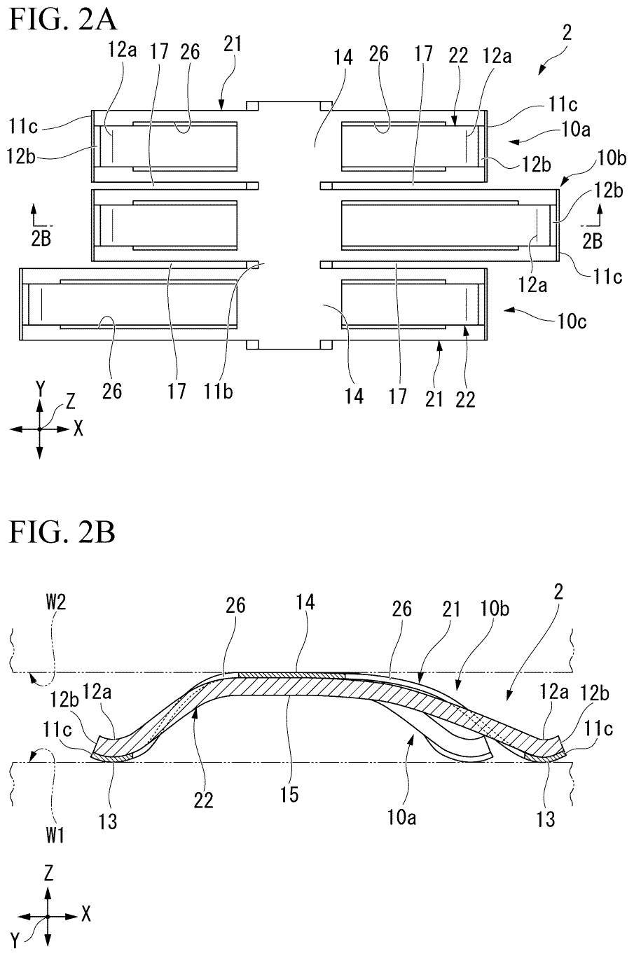

Next, a spring member 2 according to a second embodiment of the present invention will be described with reference to FIGS. 2A and 2B.

In the second embodiment, the same portions as the constituent elements in the first embodiment will be denoted by the same reference signs, descriptions thereof will be omitted, and only different points will be described.

In the spring member 2 of the present embodiment, the slit 17 is also formed at a portion located on the side of the other end portion in the second direction X, in a part that connects a support plate 22 (second member) of the first spring unit 10a and the support plate 22 of the second spring unit 10b. That is, the support plates 22 adjacent to each other in the third direction Y are connected to each other only at intermediate portions in the second direction X via a connecting piece, in the same manner as a conductive plate 21 (first member).

The through-hole 16 is not formed in the support plate 22, and through-holes 26 are formed in the conductive plate 21. Both end portions of the support plate 22 in the second direction X are respectively inserted into the through-holes 26 of the conductive plate 21 in directions from the inner side to the outer side in the second direction X.

As described above, with the spring member 2 according to the present embodiment, similarly to the spring member 1 of the first embodiment, characteristics of the spring member 2, such as conductivity and heat transfer properties, can be stably exhibited as designed.

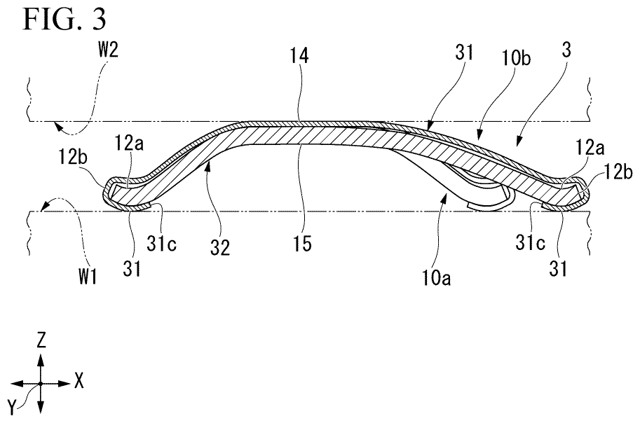

Next, a spring member 3 according to a third embodiment of the present invention will be described with reference to FIG. 3.

In the third embodiment, the same portions as the constituent elements in the first embodiment will be denoted by the same reference signs, descriptions thereof will be omitted, and only different points will be described.

In the spring member 3 of the present embodiment, the through-holes 16 and 26 are not formed in a conductive plate 31 (first member) and a support plate 32 (second member). The conductive plate 31 covers a surface of the support plate 32 facing the other side over the entire length in the second direction X. Both end portions of the conductive plate 31 in the second direction X span the open end edges 12b of the support plate 32 in the second direction X from the other side to one side, and are wound around both end portions of the support plate 32 in the second direction X.

In the spring member 3, both end portions of the conductive plate 31 in the second direction X tighten, in the first direction Z, both end portions of the support plate 32 in the second direction X, and both end portions of the support plate 32 and both end portions of the conductive plate 31 in the second direction X are fixed to each other. In the spring member 3, the first abutting portions 13 extend in the second direction X such that open end edges 31c of the conductive plate 31 in the second direction X face inward in the second direction X.

As described above, with the spring member 3 according to the present embodiment, similarly to the spring member 1 of the first embodiment, characteristics of the spring member 3, such as conductivity and heat transfer properties, can be stably exhibited as designed.

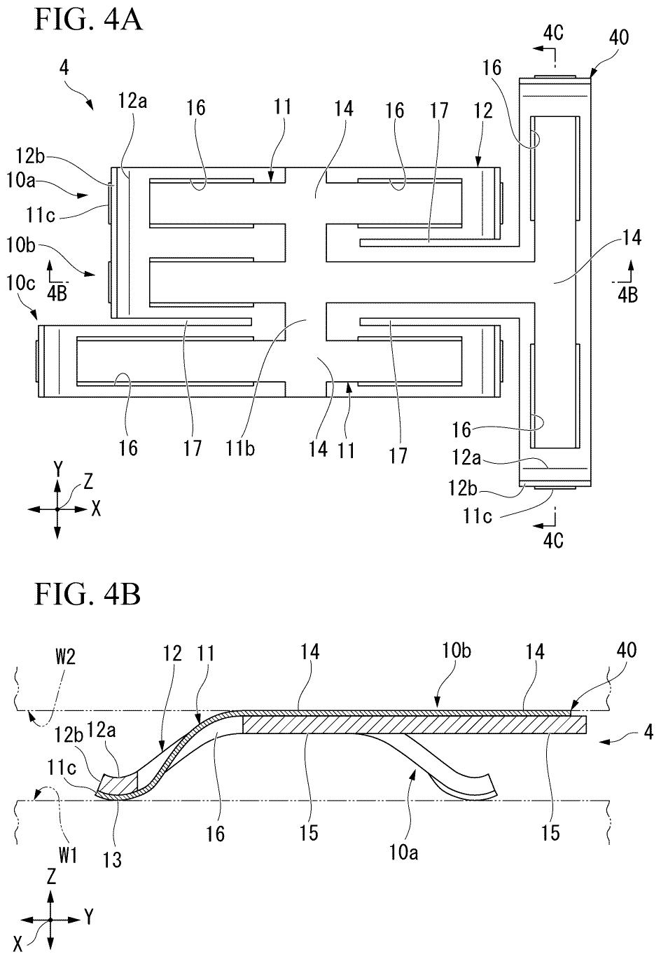

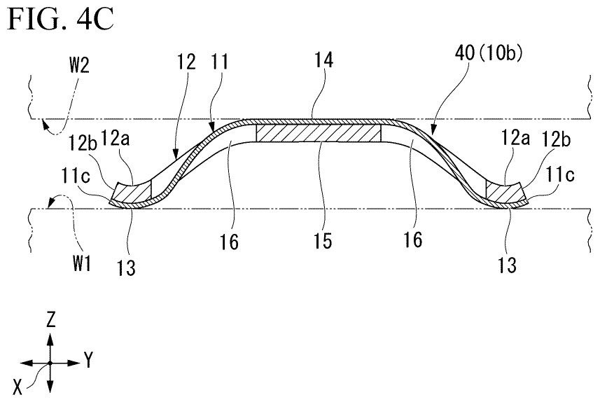

Next, a spring member 4 according to a fourth embodiment of the present invention will be described with reference to FIGS. 4A, 4B, and 4C.

In the fourth embodiment, the same portions as the constituent elements in the first embodiment will be denoted by the same reference signs, descriptions thereof will be omitted, and only different points will be described.

In the spring member 4 of the present embodiment, one end portion 40 of the second spring unit 10b in the second direction X is separated from one end portion of the first spring unit 10a in the second direction X and from one end portion of the third spring unit 10c in the second direction X, toward the side of one end portion in the second direction X, and extends in the third direction Y. The second spring unit 10b has a T-shape as viewed in the first direction Z, and has a symmetrical shape with respect to a straight line that passes through a center portion of the second spring unit 10b in the third direction Y and extends in the second direction X.

The one end portion 40 of the second spring unit 10b in the second direction X has the same configuration as a form of the first spring unit 10a rotated by 90° around an axis extending in the first direction Z, and includes the first abutting portions 13, the second abutting portion 14, the third abutting portion 15, and the through-holes 16. The one end portion 40 is provided with two of the first abutting portions 13 and the through-holes 16 each, and one each of the second abutting portion 14 and the third abutting portion 15. In the one end portion 40 of the second spring unit 10b in the second direction X, the first abutting portions 13 and the through-holes 16 are provided at both end portions in the third direction Y, and the second abutting portion 14 and the third abutting portion 15 are provided at an intermediate portion in the third direction Y.

Both end portions, in the third direction Y, of the one end portion 40 of the second spring unit 10b in the second direction X are located outside the first spring unit 10a and the third spring unit 10c in the third direction Y. A portion of the second spring unit 10b located between the connecting piece 11b and the one end portion 40 in the second direction X is formed in a flat plate shape with front and back surfaces facing the first direction Z over the entire region of the second direction X.

As described above, with the spring member 4 according to the present embodiment, similarly to the spring member 1 of the first embodiment, characteristics of the spring member 4, such as conductivity and heat transfer properties, can be stably exhibited as designed.

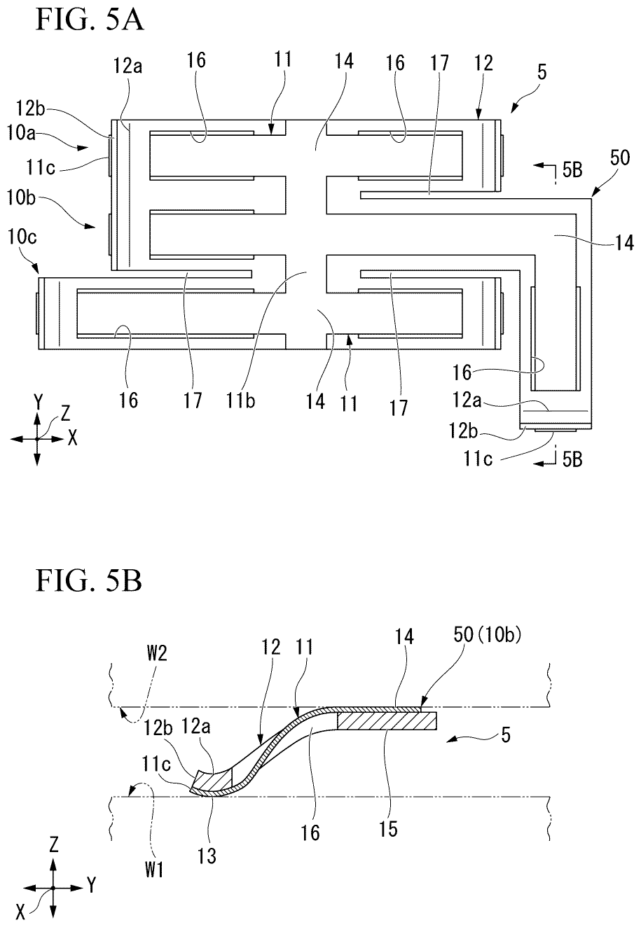

Next, a spring member 5 according to a fifth embodiment of the present invention will be described with reference to FIGS. 5A and 5B.

In the fifth embodiment, the same portions as the constituent elements in the fourth embodiment will be denoted by the same reference signs, descriptions thereof will be omitted, and only different points will be described.

In the spring member 5 of the present embodiment, the second spring unit 10b has an L-shape as viewed in the first direction Z, and one end portion 50 of the second spring unit 10b in the second direction X is provided with one each of the first abutting portion 13, the second abutting portion 14, the third abutting portion 15, and the through-hole 16.

As described above, with the spring member 5 according to the present embodiment, similarly to the spring member 4 of the fourth embodiment, characteristics of the spring member 5, such as conductivity and heat transfer properties, can be stably exhibited as designed.

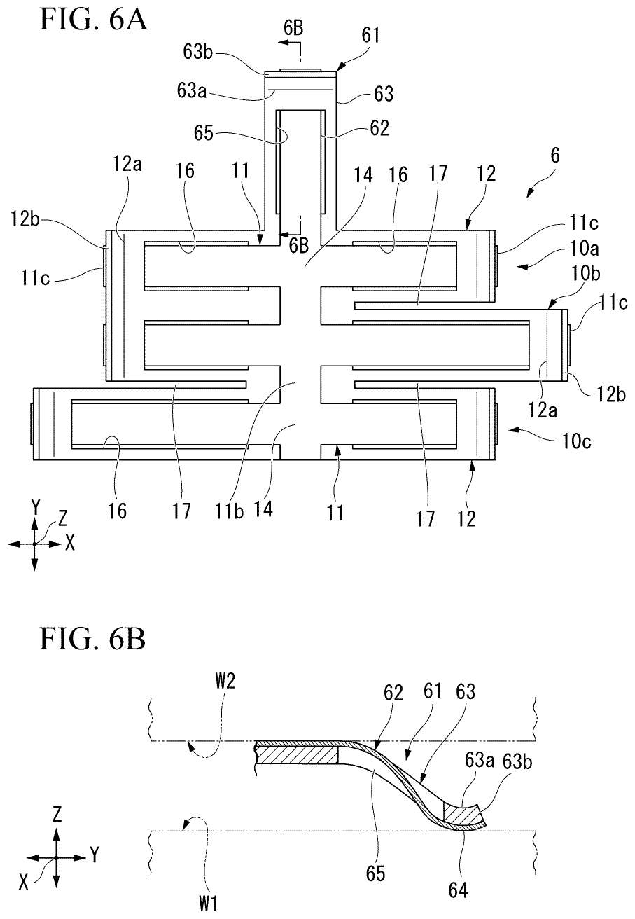

Next, a spring member 6 according to a sixth embodiment of the present invention will be described with reference to FIGS. 6A and 6B.

In the sixth embodiment, the same portions as the constituent elements in the first embodiment will be denoted by the same reference signs, descriptions thereof will be omitted, and only different points will be described.

In the spring member 6 of the present embodiment, a protruding portion 61 that protrudes in the third direction Y is provided to at least one spring unit 10a to 10c of the plurality of spring units 10a, 10b, and 10c. The protruding portion 61 is provided between the first pressed body W1 and the second pressed body W2 in a state of being elastically deformed in the first direction Z. In the shown example, the protruding portion 61 is provided at the center portion of the first spring unit 10a in the second direction X. The protruding portion 61 may be provided to any of the plurality of spring units 10a, 10b, and 10c.

The protruding portion 61 includes a conductive portion 62 that is integrally formed of the same material as the conductive plate 11, and a support portion 63 that is integrally formed of the same material as the support plate 12.

A fourth abutting portion 64 that abuts on the first pressed body W1 or the second pressed body W2 is formed at a tip end portion of the conductive portion 62 in the third direction Y. In the shown example, the fourth abutting portion 64 abuts on the first pressed body W1, but may abut on the second pressed body W2.

The tip end portion of the conductive portion 62 in the third direction Y is locked to a tip end portion of the support portion 63 in the third direction Y. A through-hole 65 is formed in the support portion 63, and the fourth abutting portion 64 of the conductive portion 62 is inserted into the through-hole 65.

An outer end edge portion 63a of the support portion 63, which is located on a side of the tip end portion in the third direction Y relative to the through-hole 65 and is connected to an open end edge 63b of the support portion 63 in the third direction Y, extends in the third direction Y such that the open end edge 63b of the support portion 63 in the third direction Y faces the side of the tip end portion in the third direction Y. The outer end edge portion 63a of the support portion 63 is curved to have a protruding curved surface toward one side. A surface of the outer end edge portion 63a of the support portion 63 facing one side is covered with the fourth abutting portion 64 of the conductive portion 62. The outer end edge portion 63a of the support portion 63 and the fourth abutting portion 64 abut on each other in a state in which the outer end edge portion 63a and the fourth abutting portion 64 are not bonded to each other. The outer end edge portion 63a of the support portion 63 and the fourth abutting portion 64 may be bonded to each other.

As described above, with the spring member 6 according to the present embodiment, similarly to the spring member 1 of the first embodiment, characteristics of the spring member 6, such as conductivity and heat transfer properties, can be stably exhibited as designed.

Since the protruding portion 61 is provided to the first spring unit 10a, the fourth abutting portion 64 of the conductive portion 62 formed of the same material as the conductive plate 11 can be brought into contact with the first pressed body W1 or the second pressed body W2, as well as the first abutting portion 13 or the second abutting portion 14. In addition, by providing the protruding portion 61 between the first pressed body W1 and the second pressed body W2 in a state of being elastically deformed in the first direction Z, the fourth abutting portion 64 of the conductive portion 62 can be strongly brought into contact with the first pressed body W1 or the second pressed body W2. As a result, characteristics such as conductivity and heat transfer properties can be stably exhibited as designed.

Since the protruding portion 61 protrudes from the first spring unit 10a in the third direction Y, it is possible to bring the conductive plate 11 and the conductive portion 62 into contact with the first pressed body W1 or the second pressed body W2 over a wide range, so that characteristics such as conductivity and heat transfer properties can be reliably improved.

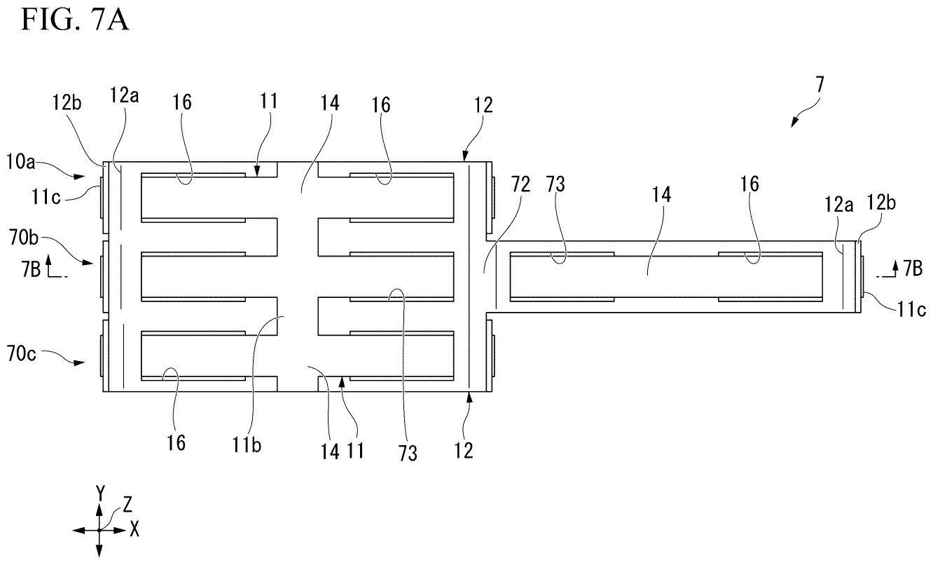

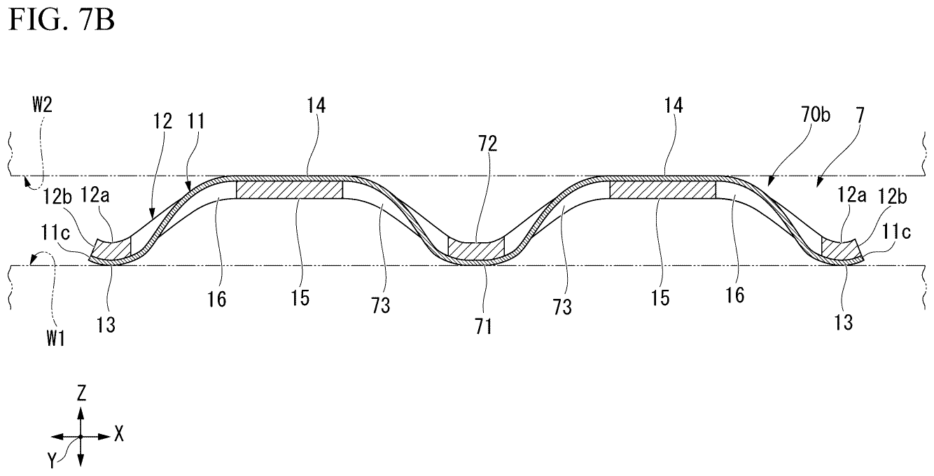

Next, a spring member 7 according to a seventh embodiment of the present invention will be described with reference to FIGS. 7A and 7B.

In the seventh embodiment, the same portions as the constituent elements in the first embodiment will be denoted by the same reference signs, descriptions thereof will be omitted, and only different points will be described.

In the spring member 7 of the present embodiment, the slit 17 is not provided, and the other end portions of all of a plurality of spring units 10a, 70b, and 70c in the second direction X are located at the same position in the second direction X, and one end portions of the first spring unit 10a and the third spring unit 70c in the second direction X are located at the same position in the second direction X.

One end portion of the second spring unit 70b in the second direction X is separated from one end portion of the first spring unit 10a in the second direction X and from one end portion of the third spring unit 70c in the second direction X, toward the side of one end portion in the second direction X.

A plurality of sets of the second abutting portion 14 and the third abutting portion 15 are provided at an intermediate portion of the second spring unit 70b in the second direction X at intervals therebetween in the second direction X. Positions of the sets of the second abutting portion 14 and the third abutting portion 15 in the first direction Z may be different from each other.

In the intermediate portion of the second spring unit 70b in the second direction X, a portion located between a first set of the second abutting portion 14 and the third abutting portion 15 and a second set of the second abutting portion 14 and the third abutting portion 15, which are adjacent to each other in the second direction X, is depressed toward one side, and is provided with a fifth abutting portion 71, a sixth abutting portion 72, and through-holes 73.

The fifth abutting portion 71 is formed in the conductive plate 11 and abuts on the first pressed body W1.

The sixth abutting portion 72 is formed in the support plate 12, and abuts on the fifth abutting portion 71 to sandwich the fifth abutting portion 71 between the sixth abutting portion 72 and the first pressed body W1 in the first direction Z.

The through-holes 73 are formed in the support plate 12 and are provided on both sides in the second direction X with the fifth abutting portion 71 and the sixth abutting portion 72 interposed therebetween. The conductive plate 11 is inserted into the through-hole 73 such that the conductive plate 11 covers a surface of the support plate 12 facing one side.

As described above, with the spring member 7 according to the present embodiment, similarly to the spring member 1 of the first embodiment, characteristics of the spring member 7, such as conductivity and heat transfer properties, can be stably exhibited as designed.

The technical scope of the present invention is not limited to the above-described embodiments, and various modifications can be made within the scope not departing from the meaning of the present invention.

Both end portions of the support plate 12, 22, 32 in the second direction X and both end portions of the conductive plate 11, 21, 31 in the second direction X may be fixed to each other by, for example, soldering.

The positions of the first abutting portions 13 formed at both end portions of the conductive plate 11, 21, 31 in the second direction X may be different from each other in the first direction Z.

In addition, the components in the above-described embodiments can be appropriately replaced with well-known components within a range not departing from the meaning of the present invention, and the embodiments and modified examples described above may be appropriately combined.

### INDUSTRIAL APPLICABILITY

According to the present invention, the characteristics of the spring member, such as conductivity and heat transfer properties, can be stably exhibited as designed.

### REFERENCE SIGNS LIST

1, 2, 3, 4, 5, 6, 7: Spring member
10a: First spring unit (spring unit)
10b, 70b: Second spring unit (spring unit)
10c, 70c: Third spring unit (spring unit)
11, 21, 31: Conductive plate (first member)
12, 22, 32: Support plate (second member)
13: First abutting portion
14: Second abutting portion
15: Third abutting portion
40, 50: One end portion
61: Protruding portion
62: Conductive portion
63: Support portion
64: Fourth abutting portion
W1: First pressed body
W2: Second pressed body
X: Second direction
Y: Third direction
Z: First direction

What is claimed is:

1. A spring member that presses a first pressed body and a second pressed body, which face each other in a first direction, in directions away from each other in the first direction, the spring member comprising:
a plurality of spring units each including a first member and a second member,
wherein the first member is formed of a material having at least one of electrical conductivity and thermal conductivity higher than a material forming the second member,
the first member includes first abutting portions which are formed at both end portions thereof in a second direction orthogonal to the first direction and abut on the first pressed body, and a second abutting portion which is formed at an intermediate portion thereof in the second direction and abuts on the second pressed body,
both end portions of the second member in the second direction press the first pressed body via the first abutting portions, and an intermediate portion of the second member in the second direction presses the second pressed body via the second abutting portion,
the plurality of spring units are provided to be arranged in a third direction orthogonal to the first direction and the second direction, and
one end portion, in the second direction, of at least one spring unit of the plurality of spring units is provided at a position shifted in the second direction from one end portion, in the second direction, of another spring unit adjacent to the at least one spring unit in the third direction.

2. The spring member according to claim 1,
wherein the first member and the second member are each curved or bent such that the intermediate portions thereof in the second direction protrude toward the second pressed body.

3. The spring member according to claim 1,
wherein a protruding portion that protrudes in the third direction is provided to at least one spring unit of the plurality of spring units,
the protruding portion includes a conductive portion that is integrally formed of the same material as the first member, and a support portion that is integrally formed of the same material as the second member,
a fourth abutting portion that abuts on the first pressed body or the second pressed body is formed at a tip end portion of the conductive portion in the third direction, and
the tip end portion of the conductive portion in the third direction is locked to a tip end portion of the support portion in the third direction.
